(19) United States
(12) Patent Application Publication
(10) Pub. No.: US 2015/0113614 A1
(43) Pub. Date: Apr. 23, 2015

(54) CLIENT BASED SYSTEMS AND METHODS FOR PROVIDING USERS WITH ACCESS TO MULTIPLE DATA BASES

(71) Applicant: Sehrope Sarkuni, Cranbury, NJ (US)

(72) Inventor: Sehrope Sarkuni, Cranbury, NJ (US)

(21) Appl. No.: 14/056,946

(22) Filed: Oct. 18, 2013

(51) Int. Cl. H04L 29/06

(52) U.S. Cl. CPC H04L 63/08
USPC 726/5

(57) ABSTRACT

An automated method for managing secure access by trusted users of a plurality of disparate databases. Each user presents a uniquely assigned set of access credentials during an authentication session, and authenticated users are connected to a proxy server. The proxy server manages access to all database(s) and intermediates any exchange of database commands and query responses which the user is authorized to initiate. A corresponding record in a user account repository is checked to identify those databases and resources which are to be made accessible to each respective user, and connections between these and the proxy server are made and torn down, on-demand. For each user, an audit log is created and updated to reflect all user database activity, and audit reports may either be generated on demand or automatically based on the occurrence of one or more selectable events.

### PRIORITY CLAIM

This application claims priority to U.S. Provisional Application No. 61/714,819 filed on Oct. 17, 2012 and entitled “MULTI USER MULTIPLE DATABASE CLIENT”, which is incorporated herein by reference in its entirely for any and all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

This disclosure relates generally to databases, and, more particularly, to systems and methods for providing users with access to one or more databases selectable from a universe of available databases.

2. Discussion of the Background Art

In organizations which generate, manage and/or analyze large volumes of data, there may be dozens or even hundreds of individuals entrusted with the task of managing the one or more datasources (e.g., relational databases, NoSQL databases, key value stores, and other types of databases) in which that data is stored. Certain categories of data may be subject to governmental regulations and restrictions such, for example, as those relating to health and financial records which are intended to protect the privacy of the individuals to whom those records pertain. It is therefore common to assign a unique set of access credentials to every user entrusted with access to a particular database. Depending upon a user's role in an organization, he or she may assigned many such sets of unique access credentials, and be expected to use them consistently. It is not uncommon, however, for a set of access credentials to be shared by a number of individuals in a given organization.

In FIG. 1, there is depicted a conventional, enterprise network configuration in which any one of users, as USER 1, USER 2, and USER 3, may gain access to each of datasources DB1, DB2, and DBn. A respective authentication service as S₁, S₂, and Sₙ is associated with a corresponding database. So long as a particular user as USER 1 is able to present a suitable set of access credentials (whether unique to that user or “borrowed” from some other user) to the desired authentication service as service S2, he or she will be gain access to the applicable datasource (in this case, relational database DB2) as an entrusted user of that database.

The prior arrangement presents challenges to both users and administrators alike. The need to remember respective combinations of user identifiers and passwords is considered a burden by many information technology (IT) professionals. The common sharing of access credentials represents a potential security threat when employees leave and even a seat license violation if, for example, the access credentials are associated with a commercial database. The sharing of access credentials also makes it difficult to construct a valid audit trail—a particularly vexing problem in organizations subject to the aforementioned privacy obligations.

From the perspective of the administrator, the need to administer multiple sets of access credentials for a periodically changing base of users often requires an ongoing expenditure of time and effort.

Finally, in situations where an enterprise network implementation permits entrusted remote users to access some or all of its datasources behind a firewall, the risk of a security breach rises arithmetically with the number of connections accommodated.

A continuing need therefore exists for a method and system which enables users to connect to datasources without the need to know, or even have assigned to them, a respective set of access credentials applicable to each corresponding datasource.

A further need exists for a system and method which allows centralized logging of activity performed by users for all of the datasources to which they are connected, to generate a complete and reliable audit trail.

Yet a further need exists for a system and method which allows users to share a common set of datasource access credentials without compromising the ability of security and compliance members to separately track and audit their activities and actions, to search the audit log using selected filter criteria such, for example, as user id, datasource id, data/time of datasource access, and the command or query executed.

Yet a further need exists for a system and method which allows an administrator to revoke access from those users who might otherwise connect to database resources using shared credentials, without the need to revoke access or alter the behavior of other users sharing those same credentials. In the prior art, this isn't explicitly addressed, and administrators traditionally ask users to “forget” any shared credentials rather than disabling those credentials.

### SUMMARY OF THE INVENTION

The aforementioned needs are addressed, and an advance is made in the art, by an automated method for managing secure access by trusted users of a plurality of disparate databases.

Each user presents a uniquely assigned set of access credentials during an authentication session, and authenticated users are connected to a proxy server. The proxy server manages access to all database(s) and intermediates any exchange of database commands and query responses which the user is authorized to initiate.

A corresponding record in a user account repository is checked to identify those databases and resources which are to be made accessible to each respective user, and connections between these and the proxy server are made and torn down, on-demand.

According to one aspect of the invention, for each user, an audit log is created and updated to reflect all user database activity, and audit reports may either be generated on demand or automatically based on the occurrence of one or more selectable events.

In accordance with another aspect of the invention, users may perform actions on multiple databases at once, as for example, actions that involve retrieving data from one database and performing an action or repeated action on another database. This includes executing a SELECT or similar action on a source database and having the results used as variables in an INSERT, UPDATE, DELETE or other modifying command on a target database.

In accordance with yet another aspect of the invention, users of the client application are permitted to generate the SQL, query, or other command text for a target database action based on the metadata of the source command, SQL, or query.

In accordance with yet another aspect of the invention, an administrator may control user access to databases through roles and privileges to restrict access to some databases to only certain users and/or groups of users. This authorization check, if performed, is separate from any authorization checks the underlying database performs, and enables those with administration privileges to easily control which users have access to which databases

In accordance with still another aspect of the invention, users are able to exchange commands, queries and data with databases attached to separate network segments from the terminals used by the users, to further enhance security. In this regard, all SQL, commands, queries, results and other data actions between the users and the databases with which they are interacting may be optionally encrypted prior to network transmission. This encryption is separate from any network encryption that the databases themselves provide and is specifically for access from the users to the secure network segment that has network access to the databases.

According to still another aspect of the invention, users may stop their work and resume without losing any “in flight” transactions or executing commands.

According to still another aspect of the invention, database drivers which require many network round trips to and from the user to the database may be operated far more efficiently than is possible using such network topologies and implementations as the prior art configuration depicted in FIG. 1.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is block diagram schematic diagram depicting a conventional network configuration by which users gain access to one or more datasources, using correspondingly different sets of access credentials and respective authentication services;

FIG. 2 is block diagram schematic depicting an exemplary network configuration incorporating a datasource access management and administration engine in accordance with the present invention;

FIG. 3 is a block schematic diagram depicting the constituent elements of an exemplary embodiment of a data source access management and administration engine according to the present invention;

FIG. 4 is a generalized schematic diagram illustrating a computer system configured to implement systems and methods according to various embodiments of the present invention;

FIG. 5 is a flowchart depicting a representative sequence of process steps performed for initial setup and ongoing administration of a datasource access management engine, such as the shown in the illustrative example of FIG. 3;

FIG. 6 is a flowchart depicting a representative sequence of process steps to achieve a simplified procedure for authenticating users and mediating the connection(s) needed to accommodate an exchange of commands, queries and data between those users and the datasources, in accordance with illustrative embodiments of the present invention;

FIG. 7 is a flow chart depicting a representative sequence of process steps for mediating the exchange of commands, queries, and data between trusted (authenticated) users and one or more datasources in accordance with illustrative embodiments of the present invention;

FIG. 8 is a flow chart depicting a representative sequence of process steps for mediating the fetching of additional data for a user responsive to one or more previously executed queries or commands;

FIG. 9 is a flow chart depicting a representative sequence of process steps for mediating the re-opening of an existing connection and fetching of additional data for a user responsive to one or more previously executed queries or commands; and

FIG. 10 is a flowchart depicting a representative sequence of process steps for implementing a request to transfer ownership of an existing connection from a donor user to an acceptor user, and to mediate the fetching of responses to open queries between for the acceptor.

### DETAILED DESCRIPTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

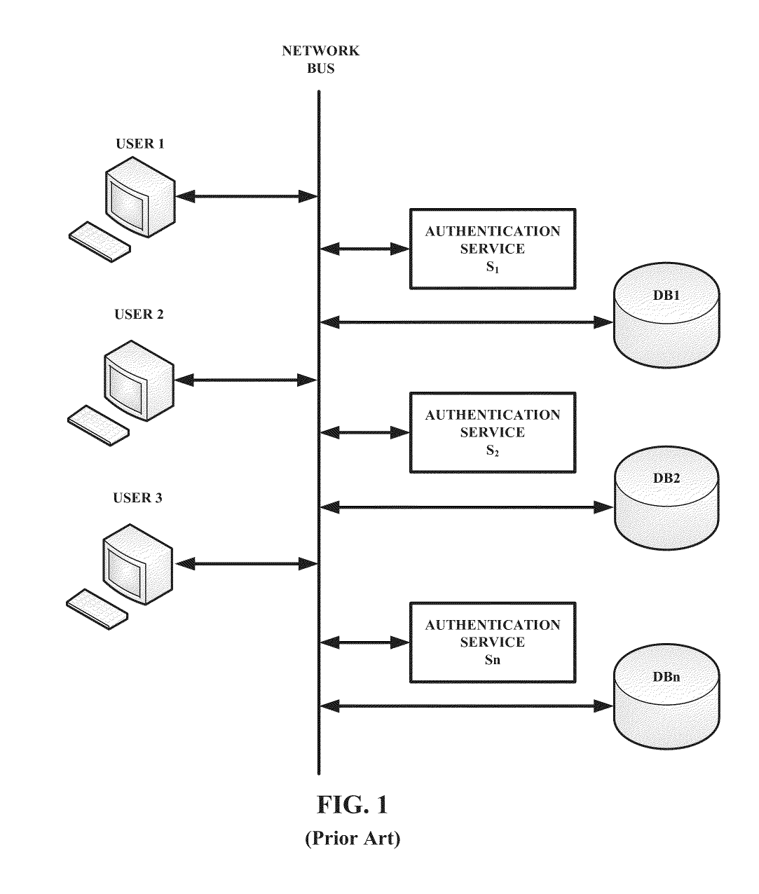

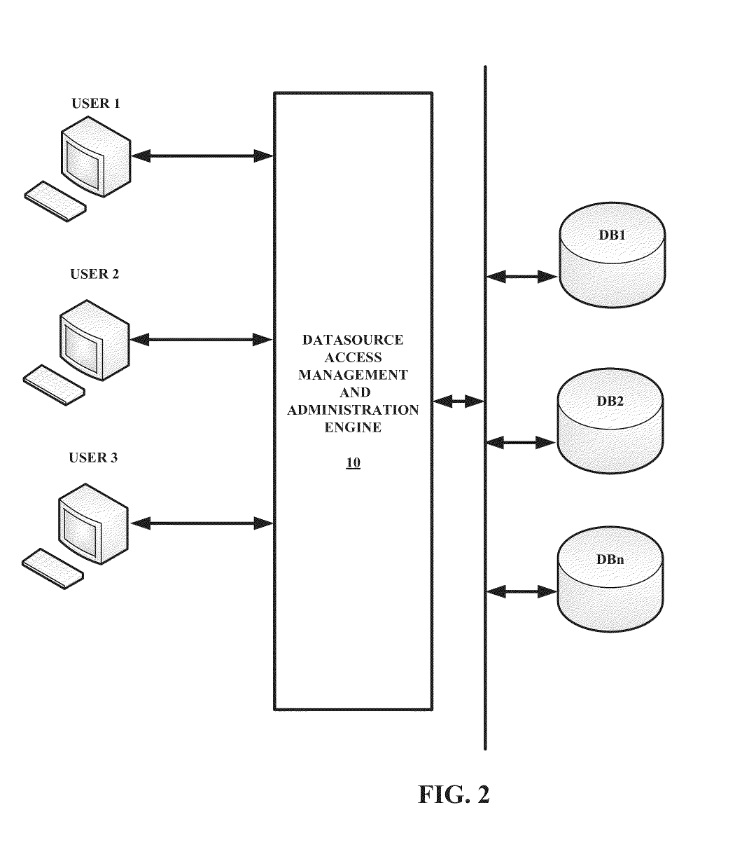

With initial reference to FIG. 2, there are shown the same users (USER 1, USER 2 and USER 3) which are entrusted with access to respective databases DB1, DB2 and DBn. In contrast with FIG. 1, however, authentication services required to facilitate the exchange of commands, queries and interactions between the terminal used by USERS 1-3 are performed by a datasource access management and administration (DAMA) engine indicated generally at 10. Persistent connections are opened over communication network links established between DAMA engine 10 and databases DB1 through DBn, at the request of the respective users. That is, where a user such as USER 1 might connect and disconnect from the DAMA 10 many times over the course of a project, the connections between DAMA 10 and one or more datasources are preferably configured to persist until a project concludes. Advantageously, this enables a user who first originated the request for a connection to transfer “ownership” of a project/connection to another user who, like the originating user, is also eligible to exercise the privileges of exchanging commands, queries and data with the applicable datasource(s).

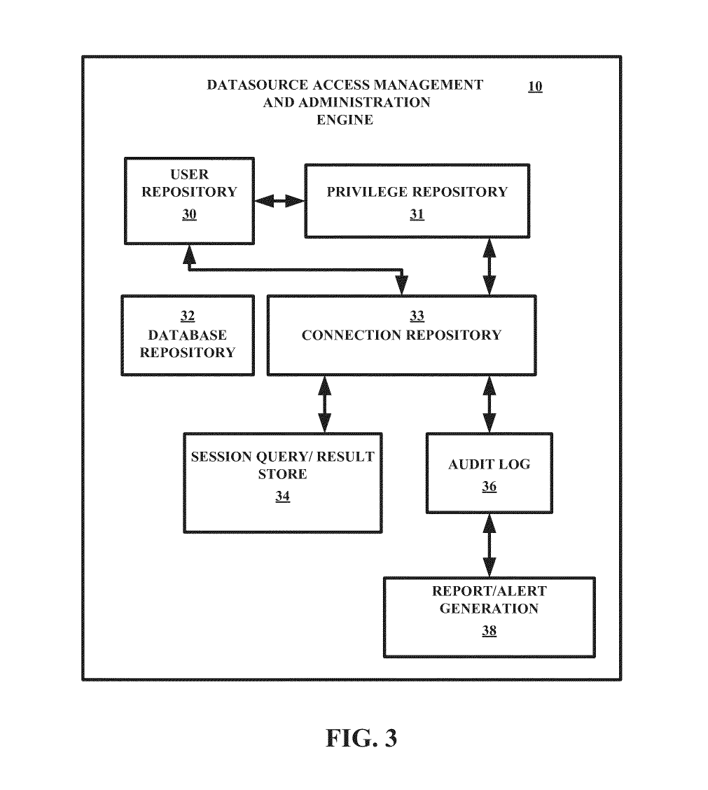

Turning now to FIG. 3, there are shown the constituent components of a DAMA engine 10 configured in accordance with an illustrative embodiment of the invention. As seen in FIG. 3, these components include a user repository, indicated generally at reference numeral 30, a privilege repository 31, a database repository 32, and a connection repository 33. A session query/result store 34 and audit log 36 are associated with connection repository 33, and a report/alert generation module indicated generally at reference numeral 38 is operatively associated with the audit log. With continued reference to FIG. 3, each of the aforementioned components will now be described in greater detail.

Within user repository 30, there is maintained a list of users of DAMA engine 10, and also instructions, executable by a processor, for authenticating them. Authentication may, for example, consist of collecting and evaluating a set of access credentials uniquely assigned to each user or the identity of a separately administered authentication service (not shown) such as LDAP or the like. Additionally, metadata about users such as first name, last name, email address, and other user details are stored and maintained by user repository 30.

Within database repository 31, there is maintained a list of databases with which respective users, if so entrusted, may exchange commands, queries, and data via the proxy functionality implemented by DAMA engine 10. The respective connection strings, usernames, and other criteria which must be presented to each corresponding datasource as DB1-DBn (FIG. 2) are stored, in accordance with instructions executed by a processor, in database repository 31. Optionally, each of these data elements may be encrypted as part of the functionality executed by the database repository function.

In accordance with the illustrative DAMA engine configuration depicted in FIG. 3, privilege repository 33 maintains the information relating each accessible database to a specific user, a list of individual users, or one or more commonly administered groups of users. By way of illustrative example, a user of DAMA engine 10 with administrative privileges may define a grouping of users based on role, office location, assignment to a given project, or any other suitable criteria, so that all members of that group can be designated, at one time, as having authorization to exchange commands, queries and data with one or more databases as some or all of databases DB1 through DBn.

Connection repository 33 of the illustrative DAMA engine of FIG. 3 is configured to store a list of open connections to databases as databases DB1 through DBn of FIG. 2. Subject to execution by a processor of instructions to check the applicable privilege and authorization records of privilege repository 31, users can open new connections, transfer existing connections, and close connections.

Query/result store 34 buffers the results of database commands, executed at the request of a user, if those commands return a result. The underlying storage for the query results may be in memory, on a persistent storage device such as a hard drive or solid state drive, or other storage, or a combination of any of the foregoing. Additionally, query/result store 34 may be configured to execute instructions for implementing encryption of the buffered query results prior to or as part of the storage functionality.

Audit log 36 comprises a store of actions that users perform or attempt to perform using DAMA engine 10. These actions include logging in, requesting a connection to a database, transferring ownership of a connection, requesting execution of a command, query, data retrieval or data forwarding function, or closing a connection. The associated report/generation module 38 implements a search interface for the stored audit data, allowing searches and reports to be generated using specified filters such as the identity of the user who initiated an action being audited, the database(s) involved, the command or query executed, the date and time range of the action, or any combination of these.

Within the terminals used by users as USERS 1-3, a client application (not shown) is executed to initiate an authentication and, as applicable, to request set up and access to a new datasource connection or use of an existing one. In the case of browser-based graphical user interface implementations, the client application software may be executed in each user's web browser.

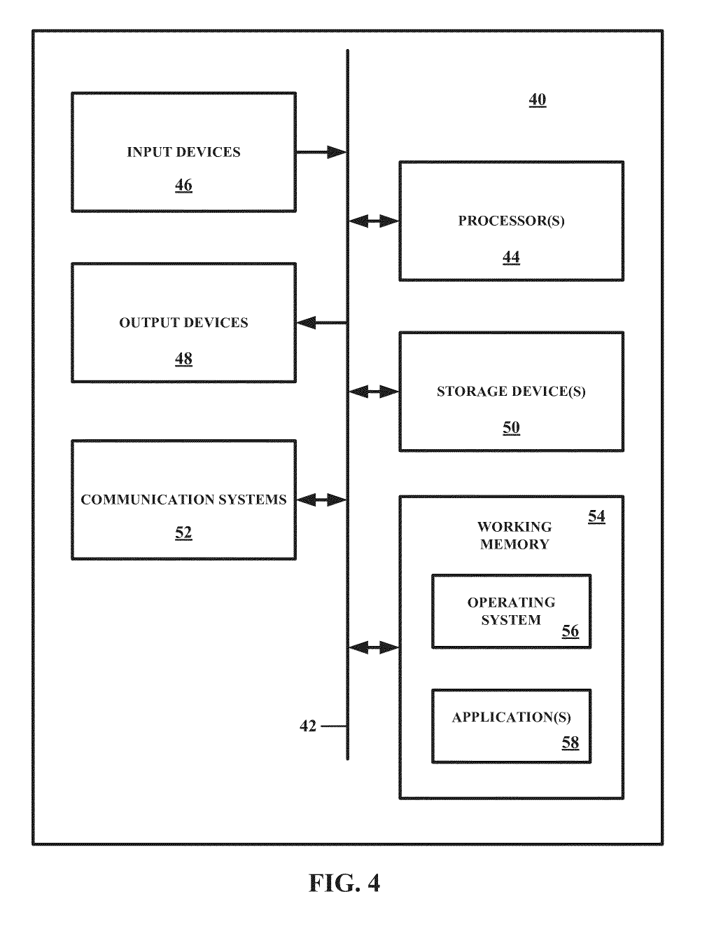

FIG. 4 provides a schematic illustration of a computer system 10 that can implement the processor executed functions and other functions described above, as well as perform process steps of the invention, as will be described in detail shortly. It will, of course, be readily appreciated by those skilled in the art that FIG. 1 is meant only to provide a generalized illustration of various components, any or all of which may be utilized as appropriate. FIG. 1, therefore, broadly illustrates how individual system elements may be implemented in a relatively separated or relatively more integrated manner.

Computer system 40 is shown comprising hardware that can be electrically coupled via a bus 42 (or may otherwise be in communication, as appropriate). The hardware elements can include one or more processors 44, including without limitation, one or more general purpose processors and/or one or more special purpose processors (such as digital signal processing chips, graphics acceleration chips, and/or the like); one or more input devices 46, which can include without limitation a mouse, a keyboard and/or the like; and one or more output devices 48, which can include without limitation a display device, a printer and/or the like.

Exemplary computer system 40 further includes (and/or be in communication with) one or more storage devices 50, which can comprise, without limitation, local and/or network accessible storage and/or can include, without limitation, a disk drive, a drive array, an optical storage device, a solid state storage device such as a random access memory (“RAM”) and/or a read-only memory (“ROM”), which can be programmable, flash updateable and/or the like. Computer system 10 might also include communications subsystems 52, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. Communications subsystem 52 permits data to be exchanged with a network (such as the network described below, to name one example), and/or any other devices described herein. In many embodiments, computer system 10 will further comprise a working memory 54, which can include a RAM or ROM device, as described above.

With continuing reference to FIG. 4, it will be seen that computer system 10 also can comprise software elements, shown as being currently located within the working memory 54, including an operating system 56 and/or other code, such as one or more application programs 58, which may comprise computer programs of the invention, and/or may be designed to implement methods of the invention and/or configure systems of the invention, as described herein. By way of illustrative example, one or more procedures described with respect to the method(s) discussed above might be implemented as code and/or instructions executable by a computer (and/or a processor within a computer). A set of these instructions and/or codes might be stored on a computer-readable storage medium, such as storage device(s) 50 as described above. In some cases, the storage medium might be incorporated within a computer system, such as the system 40.

In other embodiments, the storage medium might be separate from a computer system (i.e., a removable medium, such as a compact disc, etc.), and is provided in an installation package, such that the storage medium can be used to program a general purpose computer with the instructions/code stored thereon. These instructions might take the form of executable code, which is executable by computer system 40 and/or might take the form of source and/or installable code, which, upon compilation and/or installation on the computer system 40 (e.g., using any of a variety of generally available compilers, installation programs, compression/decompression utilities, etc.), then takes the form of executable code

It will be apparent to those skilled in the art that substantial variations may be made in accordance with specific requirements. For example, customized hardware might also be used, and/or particular elements might be implemented in hardware, software (including portable software, such as applets, etc.), or both. Further, connection(s) to other computing devices such as network input/output devices may be employed.

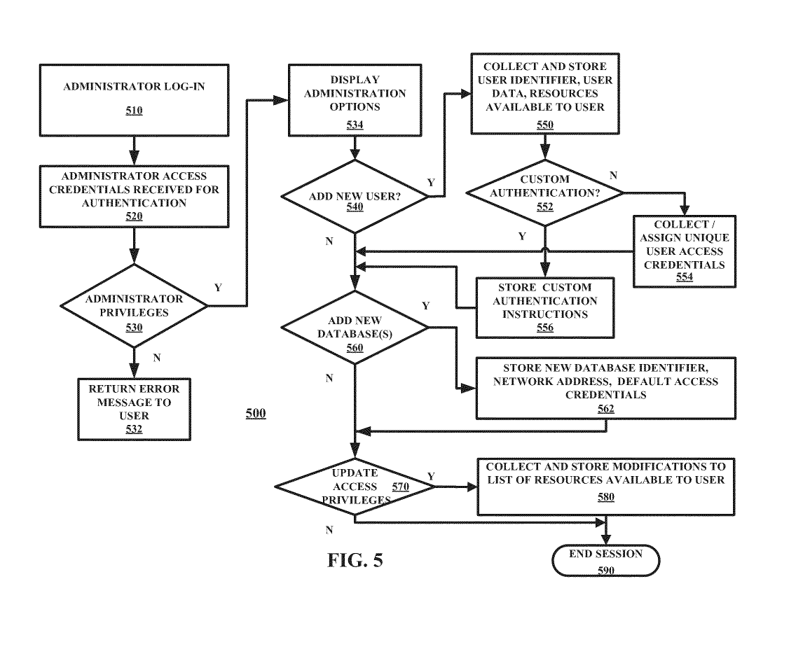

With simultaneous reference now to FIGS. 3 and 5, there is depicted a representative sequence of process steps performed to setup and administer a DAMA engine as the DAMA engine 10 of FIG. 3, in order to mediate access to database resources, by proxy, for users of terminals equipped with a browser-based client application. The process is executed at block 510, wherein a processor executes an authentication process to ensure that the user requesting the exercise of administrative privileges is entitled to do so. These credentials are presented at block 520, and at decision block 530, a decision is made as to whether these credentials are defective or otherwise insufficient to grant administrative access. If so, then the process proceeds to block 532 and an error message is returned to the user. Optionally, entries for the error message, date and time of the log in attempt, and the identity of the user requesting administration privileges may be stored in audit log 36. If the credentials are sufficient, the process proceeds to block 534, wherein a display screen is rendered on the user terminal to display the administrative options from which the administrator may select. For example, at decision block 540, if the administrator seeks to add a new user, the process proceeds to block 550 wherein user meta data and assigned access credentials may be collected. As described earlier, this data is stored in user repository 30. Optionally, the administrator may elect at decision block 552 to set up custom authentication instructions. If so, these are stored for subsequent execution by the processor (not shown) which implements the functionality of DAMA engine 10. If not, then the administrator may specify a unique set of access credentials to be assigned to the user. Alternatively, the system may automatically generate such credentials and forward them to the new user using contact information furnished as meta data.

In any event, and with continued reference to FIG. 5, it will be seen that the process proceeds to decision block 560 wherein the administrator may opt to provision additional databases. If so, the process proceeds to block 562, with such information as the database identifier and set of default access credentials being collected and stored in the database repository 32. Thereafter, or if no databases are to be added, the process proceeds to block 570. If changes in a user's access privileges are to be made (de-activation of one or more user accounts, for example), the needed modifications are collected and implemented at block 580. Thereafter, or if no other administrative functions are to be implemented, the process terminates at terminal block 590.

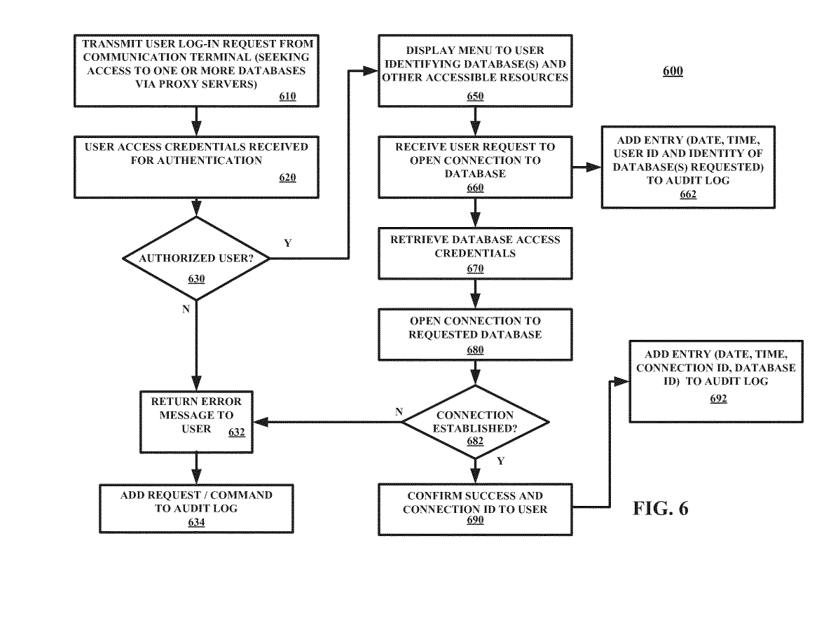

With reference now to FIGS. 3 and 6, there is shown a flowchart depicting a representative sequence of steps executed by a processor, as processor(s) 44 of FIG. 4, to achieve a simplified procedure for authenticating users and mediating the connection(s) needed to accommodate an exchange of commands, queries and data between those users and the datasources. The process is entered at block 610, wherein the user forwards a log-in request from an associated communication terminal in order to gain access to one or more databases via the proxy server functionality of DAMA engine 10. At block 610, the user access credentials are received for authentication by DAMA engine 10. If the user is not successfully authenticated at decision block 630, the process proceeds to block 632 and an error message is returned to the user. An entry documenting the authentication request is made in audit log 36 and the process terminates. If, however, the user is successfully authenticated, the process advances to block 650, wherein a display screen is rendered to the client application executed on the user's browser, presenting the user with a menu of databases to which connections can be made, by proxy, from DAMA engine 10.

At block 660, a user request is received from the user to open a connection to a first database. An entry (date, time, user id, and identity of requested database) is made, in audit log 36, at block 662. The process then advances to block 670, at which point database access credentials 670 are retrieved, and then at block 680, a connection is opened to the requested database. If at decision block 682 it is determined that a connection cannot be established, then the process proceeds to block 632, an error message is returned to the user, and an entry is made of the aborted attempt (block 634) in audit log 36.

If it is determined at decision block 682 that a connection has been established, success is confirmed at block 690 and a connection ID is stored and also transmitted to the user. An entry in audit log 36 is made to document the date, time, connection id, and database to which the connection was made.

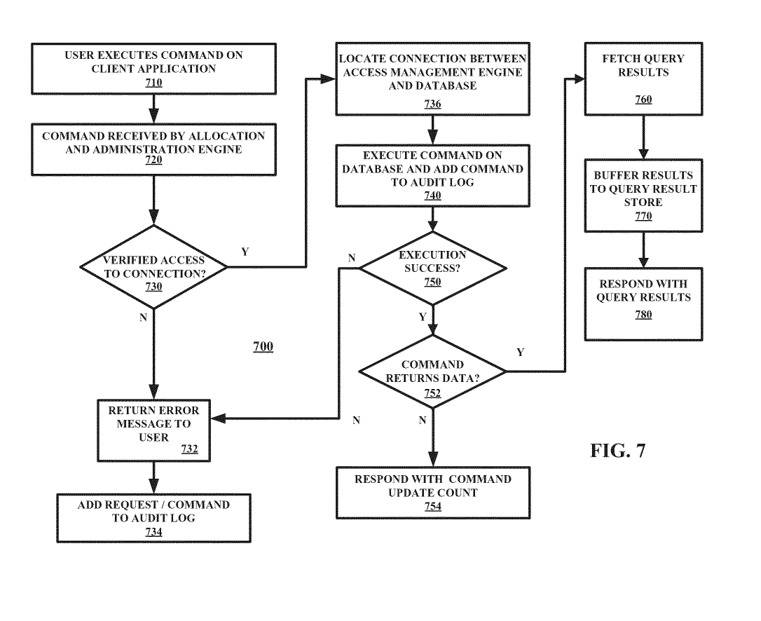

With reference now to FIGS. 3 and 7, there is shown a flowchart depicting a representative sequence of steps executed by a processor, as processor(s) 44 of FIG. 4, to achieve a simplified procedure for mediating the exchange of commands, queries and data between a user of DAMA engine 10 and the datasources to which it is connected. The process is entered at block 710, wherein the user executes a command in the client application at his or her terminal. At block 720, the command is received by DAMA engine 10, and at decision block 730 a decision is made as to whether the user is verified as having access to a proxy-mediated database connection. If the user is not successfully verified at block 730, the process proceeds to block 732 and an error message is returned to the user. At block 734, an entry documenting the requested proxy-mediated command is made in audit log 36 and the process terminates. If, however, the user is successfully verified, the process advances to block 736, wherein the connection between DAMA engine 10 and the database is located, and thereafter to block 740 where a request is made by DAMA engine 10 to have the user requested command executed by the database.

At decision block 750, if the requested command does not execute, then an error message is returned to the user (block 732) and entry of the unsuccessful attempt is made in the audit log 36 (block 734). An entry is made in audit log 36 to reflect the successful execution of the command by the database. If the command returns data at block 752, If the execution was successful, a corresponding entry confirming this fact is made in audit log 36, and the process proceeds to block 752. If the command does not return data, then the user receives a response including a command update count (block 754). If data is returned, DAMA engine 10 fetches the query results (block 760), the results are buffered by the query result store (block 770), and responds to the user with the query results (block 780).

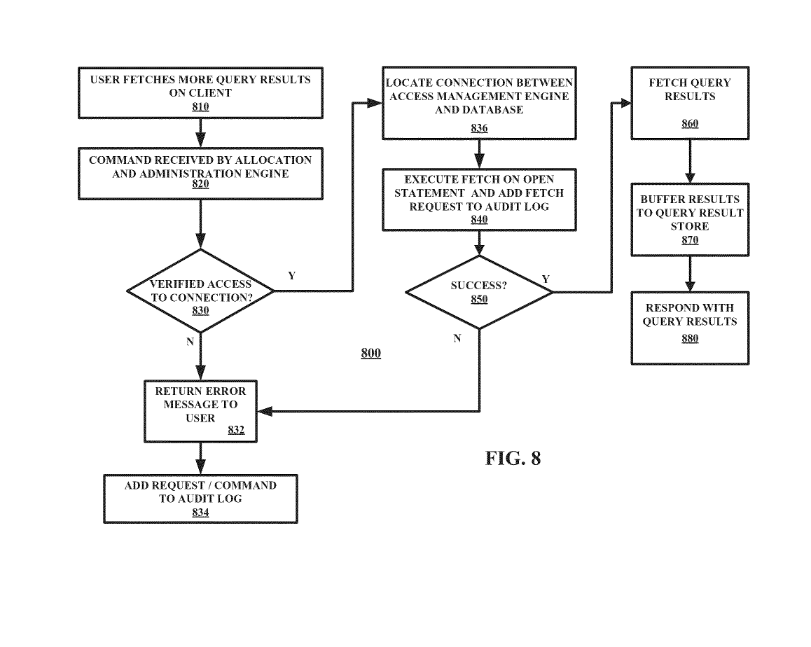

With reference now to FIGS. 3 and 8, there is shown a flowchart depicting a representative sequence of steps executed by a processor, as processor(s) 44 of FIG. 4, to achieve a simplified procedure for mediating the further fetching of query results by DAMA engine 10 from the datasource(s) to which it is connected. The process is entered at block 810, wherein the user invokes a fetch request using the client application at his or her terminal. At block 820, the command is received by DAMA engine 10, and at decision block 830 a decision is made as to whether the user is verified as having access to a proxy-mediated database connection to implement the request. If the user is not successfully verified at block 830, the process proceeds to block 832 and an error message is returned to the user. At block 834, an entry documenting the requested proxy-mediated command is made in audit log 36 and the process terminates. If, however, the user is successfully verified, the process advances to block 836, wherein the connection between DAMA engine 10 and the database is located, and thereafter to block 840 where a request is made by DAMA engine 10 to have the user requested command executed by the database. An entry is made in audit log 36 to document the fetch execution request.

At decision block 850, if the requested command does not execute, then an error message is returned to the user (block 832) and entry of the unsuccessful attempt is made in the audit log 36 (block 834). An entry is made in audit log 36 to reflect the successful execution of the fetch instruction. At block 860, the query results are fetched, buffered in query result store (block 870), and DAMA engine 10 responds to the user with the query results (Block 880).

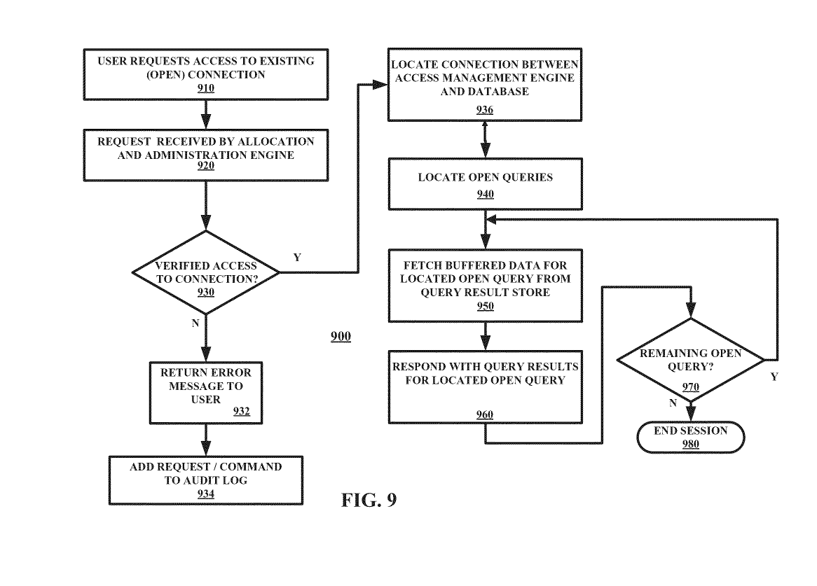

With reference now to FIGS. 3 and 9, there is shown a flowchart depicting a representative sequence of steps executed by a processor, as processor(s) 44 of FIG. 4, to achieve a simplified procedure for resuming an interrupted, mediated exchange of commands, queries and/or data between a user of DAMA engine 10 and the datasources to which DAMA engine 10 is connected. The process is entered at block 910, wherein the user executes a request to access an existing (open) connection between the DAMA engine 10 and a database, using the client application at his or her terminal. At block 920, the command is received by DAMA engine 10, and at decision block 930 a decision is made as to whether the user is verified as having access to a proxy-mediated database connection. If the user is not successfully verified at block 930, the process proceeds to block 932 and an error message is returned to the user. At block 934, an entry documenting the requested proxy-mediated command is made in audit log 36 and the process terminates. If, however, the user is successfully verified, the process advances to block 936, wherein the connection between DAMA engine 10 and the database is located, and thereafter to block 940 wherein open queries are located. The successful location is documented by an entry in audit log 36.

The process proceeds to block 950, wherein buffered data is fetched for a located open query form the query result store. DAMA engine 10 returns a response to the user containing the query results for the located open query. If, at decision block 970, it is determined that another open query remains, the process is re-entered at block 950, and steps 950 and 960 are performed until no further open queries remain (unless the user interrupts the session before that). Thereafter, the process terminates at block 980.

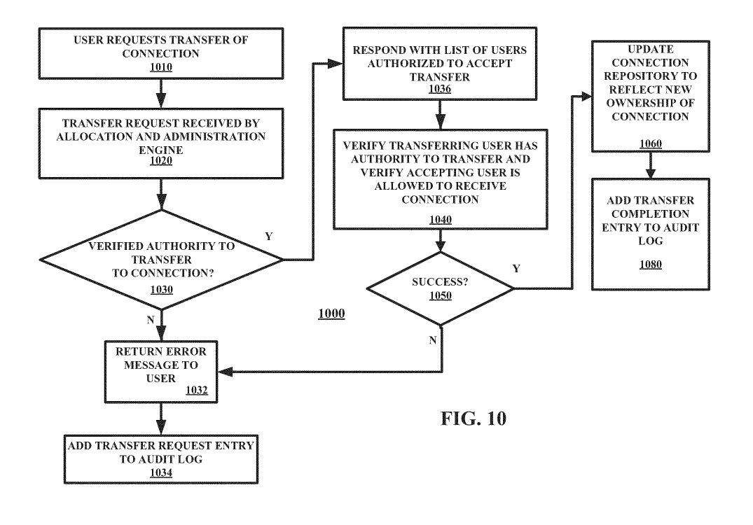

FIG. 10 is a flowchart depicting a representative sequence of process steps for implementing a request to transfer ownership of an existing connection from a donor user to an acceptor user, and to mediate the fetching of responses to open queries between for the acceptor. With reference now to both FIGS. 3 and 10, it will be seen the process is entered at block 1010, wherein the user executes a command in the client application at his or her terminal to request transfer of a connection to another user. At block 1020, the transfer request is received by DAMA engine 10, and at decision block 1030 a decision is made as to whether the user is verified as having authority to request a transfer of a proxy-mediated database connection to another user. If the user is not successfully verified at block 1030, the process proceeds to block 1032 and an error message is returned to the user. At block 1034, an entry documenting the requested proxy-mediated action is made in audit log 36 and the process terminates. If, however, the user is successfully verified, the process advances to block 1036, wherein a display is rendered to the connection-donating user to show a list of users authorized to accept the role of “owner” of the connection. At block 1040, before DAMA engine 10 actually implements the transferred connection, a final check is made to verify that the donating user has authority to make the transfer and that the accepting user has authority to receive the connection. If the verification is unsuccessful, at block 1050 the process proceeds to block 1032, returning an error message to the user, and an entry is made in the audit log to reflect the failed verification (block 1034). If it is successful, then the connection depository 33 is updated to reflect the new connection “owner” and a transfer completion entry is made in audit log 36 (block 1080).

Although certain example methods, apparatus and articles of manufacture have been described herein, the scope of coverage of this patent is not limited thereto. Rather, this patent covers all methods, apparatus and articles of manufacture falling within the scope of the appended claims either literally or under the doctrine of equivalents.

What is claimed:

1. An automated method for managing secure access by trusted users of a plurality of disparate databases, wherein access to at least some of the databases is conditioned upon presenting a corresponding set of access credentials, the method comprising:
authenticating, with a processor, a first user presenting a first set of access credentials and seeking a connection to a first of the disparate databases during a first log-in session;
establishing a communication link between a terminal used by the first user and a proxy server operative to establish a connection to any of the disparate databases;
determining, with the processor, whether the first user has been entrusted with access to a first database; and
if the first user has been entrusted with access to the first database, retrieving and presenting, using the processor, a second set of access credentials to thereby establish a communication link between the proxy server and the first database, wherein the first set of access credentials are different from the second set of access credentials.

2. The method of claim 1, further including
determining, with the processor, whether the first user has been entrusted with access to a second of the disparate databases; and
if the first user has been entrusted with access to the second database, retrieving and presenting, using the processor, a third set of access credentials to thereby establish a first communication link between the proxy server and the second database, wherein the third set of access credentials are different from the first and second set of access credentials.

3. The method of claim 2, further including
receiving, at the proxy server, a first executable database command from the first user, and
forwarding the first executable database command over the first communication link for execution on the first database.

4. The method of claim 3, further including maintaining an audit log including an entry for each executable database command forwarded for execution by the first database.

5. The method of claim 4, further including receiving, at the proxy server, data responsive to the first executable database command and returned by the first database after execution.

6. The method of claim 5, further comprising a step of including, in the audit log, an entry for all data responsive to each executable database command and returned by the first database following execution.

7. The method of claim 6, further including a step of receiving a request from the first user to terminate the first log-in session, and terminating applicable communication links between the proxy server and the first and second databases respectively.

8. The method of claim 7, further including
establishing, subsequent to the first log-in session, a second log-in session between a terminal used by the first user and the proxy server, wherein communication links are established between the proxy server and the first and second databases, respectively; and
updating the audit log to include entries for at least one of executable database commands received from the first user and data from query results returned by the first and second databases during the second log-in session.

9. The method of claim 6, further including a step of forwarding to the first user all data responsive to each executable database command and returned by the first database following execution.

10. The method of claim 5, further including a step of forwarding to the first user all data responsive to each executable database command and returned by the first database following execution.

11. The method of claim 3, wherein the first executable database command is one of a SELECT, INSERT, UPDATE, and DELETE command.

12. The method of claim 2, further including
authenticating, with the processor, a second user presenting a fourth set of access credentials and seeking a connection to the first of the disparate databases;
establishing a communication link between a terminal used by the second user and the proxy server,
determining, with the processor, whether the second user has been entrusted with access to the first database; and
if the second user has been entrusted with access to the first database, retrieving and presenting, using the processor, the second set of access credentials to thereby establish a second communication link between the proxy server and the first database.

13. The method of claim 2, further including a step of recording, in an audit log, an entry documenting each user request to establish a connection between the proxy server and any of the first and second databases.

14. The method of claim 3, further including a step of recording, in an audit log, an entry documenting each user request to execute a proxy-mediated command facilitated by a connection between the proxy server and any of the first and second databases.

14. The method of claim 1, further including a step of recording, in an audit log, an entry documenting each user request to establish a connection between the proxy server and the first database.

15. The method of claim 14, further including a step of recording, in the audit log, whether or not each user request to establish a connection between the proxy server and the first database was successful.

16. The method of claim 1, further including a step of authenticating a request by the first user to transfer a connection established between the proxy server and the first database to a second user.

17. The method of claim 16, further including a step of transferring ownership of resources associated with a connection established between the proxy server and the first database responsive to successful authentication of a transfer request.
